(19) United States
(12) Patent Application Publication
(10) Pub. No.: US 2016/0160888 A1
(43) Pub. Date: Jun. 9, 2016

(54) ROTOR DUCT SPOTFACE FEATURES

(71) Applicant: Energy Recovery, Inc., San Leandro, CA (US)

(72) Inventor: Patrick William Morphew, San Leandro, CA (US)

(21) Appl. No.: 14/957,347

(22) Filed: Dec. 2, 2015

Related U.S. Application Data
(60) Provisional application No. 62/088,403, filed on Dec. 5, 2014.

(51) Int. Cl. F15B 15/06

(52) U.S. Cl. CPC F15B 15/063

(57) ABSTRACT

A system includes a rotary isobaric pressure exchanger that includes a rotor. The rotor includes a first spotface formed on a first exterior surface of a first longitudinal end of the rotor adjacent to at least one channel. The at least one channel is disposed within the rotor and is configured to receive and to discharge a fluid flow.

### CROSS-REFERENCE TO RELATED APPLICATIONS

This application is a non-provisional of U.S. Provisional Patent Application No. 62/088,403, entitled “ROTOR DUCT SPOTFACE FEATURES”, filed Dec. 5, 2014, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Fluid handling equipment, such as rotary pumps and pressure exchangers, may be susceptible to loss in efficiency, loss in performance, wear, and sometimes breakage over time. As a result, the equipment must be taken off line for inspection, repair, and/or replacement. Unfortunately, the downtime of this equipment may be labor intensive and costly for the particular plant, facility, or work site. In certain instances, the fluid handling equipment may be susceptible to misalignment, imbalances, or other irregularities, which may increase wear and other problems, and cause unexpected downtime. This equipment downtime is particularly problematic for continuous operations. Therefore, a need exists to increase the reliability and longevity of fluid handling equipment.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic diagram of an embodiment of a frac system with a hydraulic energy transfer system;

FIG. 2 is a schematic diagram of an embodiment of an isobaric pressure exchanger (IPX);

FIG. 3 is an exploded perspective view of an embodiment of a rotary isobaric pressure exchanger (rotary IPX);

FIG. 4 is an exploded perspective view of an embodiment of a rotary IPX in a first operating position;

FIG. 5 is an exploded perspective view of an embodiment of a rotary IPX in a second operating position;

FIG. 6 is an exploded perspective view of an embodiment of a rotary IPX in a third operating position;

FIG. 7 is an exploded perspective view of an embodiment of a rotary IPX in a fourth operating position;

FIG. 8 is an axial view of an embodiment of an end cover of the rotary IPX of FIG. 2;

FIG. 9 is an axial view of an embodiment of a rotor overlaid on an end cover of the rotary IPX of FIG. 2;

FIG. 10 is an axial view of an embodiment of a rotor of the rotary IPX of FIG. 2;

FIG. 11 is an axial view of an embodiment of a rotor overlaid on an end cover of the rotary IPX of FIG. 2;

FIG. 12 is cross-sectional view of an embodiment of a spotface feature of the rotor of FIG. 10; and

FIG. 13 is a cross-sectional view of a further embodiment of a spotface feature of the rotor of FIG. 10.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, a hydraulic energy transfer system transfers work and/or pressure between a first fluid (e.g., a pressure exchange fluid) and a second fluid (e.g., frac fluid or a salinated fluid). In certain embodiments, the first fluid may be substantially “cleaner” than the second fluid. In other words, the second fluid may contain dissolved and/or suspended particles. Moreover, in certain embodiments, the second fluid may be more viscous than the first fluid. Additionally, the first fluid may be at a first pressure between approximately 5,000 kPa to 25,000 kPa, 20,000 kPa to 50,000 kPa, 40,000 kPa to 75,000 kPa, 75,000 kPa to 100,000 kPa or greater than a second pressure of the second fluid. In operation, the hydraulic energy transfer system may or may not completely equalize pressures between the first and second fluids. Accordingly, the hydraulic energy transfer system may operate isobarically, or substantially isobarically (e.g., wherein the pressures of the first and second fluids equalize within approximately +/−1, 2, 3, 4, 5, 6, 7, 8, 9, or 10 percent of each other).

The hydraulic energy transfer system may also be described as a hydraulic protection system, hydraulic buffer system, or a hydraulic isolation system, because it blocks or limits contact between the second fluid and various pieces of hydraulic equipment (e.g., high-pressure pumps, heat exchangers), while still exchanging work and/or pressure between the first and second fluids. By blocking or limiting contact between various pieces of hydraulic equipment and the second fluid (e.g., more viscous fluid, fluid with suspended solids, and/or abrasive fluid), the hydraulic energy transfer system reduces abrasion/wear, thus increasing the life/performance of this equipment (e.g., high-pressure pumps). Moreover, it may enable the hydraulic system to use less expensive equipment, for example high-pressure pumps that are not designed for abrasive fluids (e.g., fluids with suspended particles). In some embodiments, the hydraulic energy transfer system may be a hydraulic turbocharger, a rotating isobaric pressure exchanger (e.g., rotary IPX), or a non-rotating isobaric pressure exchanger (e.g., bladder, reciprocating isobaric pressure exchanger). Rotating and non-rotating isobaric pressure exchangers may be generally defined as devices that transfer fluid pressure between a high-pressure inlet stream and a low-pressure inlet stream at efficiencies in excess of approximately 50%, 60%, 70%, 80%, or 90% without utilizing centrifugal technology.

As explained above, the hydraulic energy transfer system transfers work and/or pressure between first and second fluids. These fluids may be multi-phase fluids such as gas/liquid flows, gas/solid particulate flows, liquid/solid particulate flows, gas/liquid/solid particulate flows, or any other multi-phase flow. Moreover, these fluids may be non-Newtonian fluids (e.g., shear thinning fluid), highly viscous fluids, non-Newtonian fluids containing proppant, or highly viscous fluids containing proppant. The proppant may include sand, solid particles, powders, debris, ceramics, or any combination therefore. For example, the disclosed embodiments may be used with oil and gas equipment, such as hydraulic fracturing equipment using a proppant (e.g., particle laden fluid) to frac rock formations in a well.

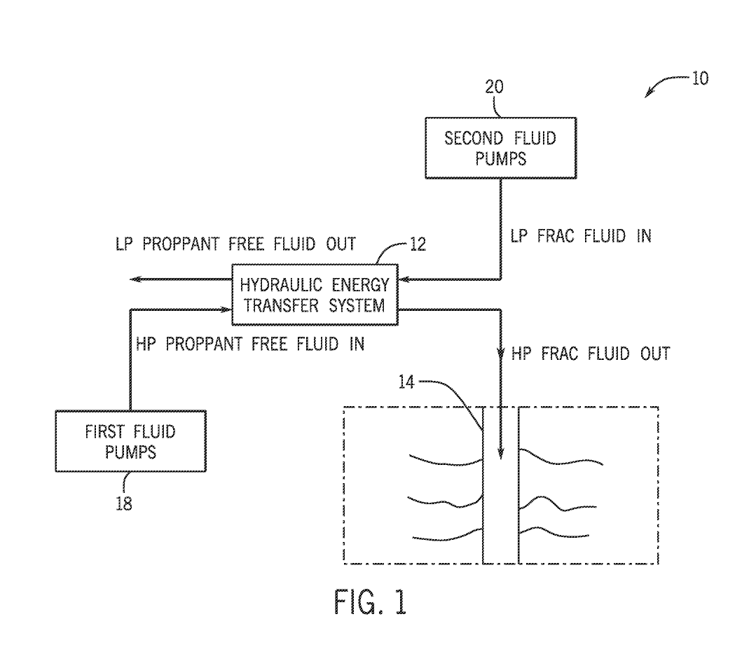

FIG. 1 is a schematic diagram of an embodiment of a frac system 10 (e.g., fluid handling system) with a hydraulic energy transfer system 12. In operation, the frac system 10 enables well completion operations to increase the release of oil and gas in rock formations. The frac system 10 may include one or more first fluid pumps 18 and one or more second fluid pumps 20 coupled to a hydraulic energy transfer system 12. For example, the hydraulic energy system 12 may include a hydraulic turbocharger, rotary IPX, reciprocating IPX, or any combination thereof. In addition, the hydraulic energy transfer system 12 may be disposed on a skid separate from the other components of a frac system 10, which may be desirable in situations in which the hydraulic energy transfer system 12 is added to an existing frac system 10. In operation, the hydraulic energy transfer system 12 transfers pressures without any substantial mixing between a first fluid (e.g., proppant free fluid) pumped by the first fluid pumps 18 and a second fluid (e.g., proppant containing fluid or frac fluid) pumped by the second fluid pumps 20. In this manner, the hydraulic energy transfer system 12 blocks or limits wear on the first fluid pumps 18 (e.g., high-pressure pumps), while enabling the frac system 10 to pump a high-pressure frac fluid into the well 14 to release oil and gas. In addition, because the hydraulic energy transfer system 12 is configured to be exposed to the first and second fluids, the hydraulic energy transfer system 12 may be made from materials resistant to corrosive and abrasive substances in either the first and second fluids. For example, the hydraulic energy transfer system 12 may be made out of ceramics (e.g., alumina, cermets, such as carbide, oxide, nitride, or boride hard phases) within a metal matrix (e.g., Co, Cr or Ni or any combination thereof) such as tungsten carbide in a matrix of CoCr, Ni, NiCr or Co.

In an embodiment using a hydraulic turbocharger, the first fluid (e.g., high-pressure proppant free fluid) enters a first side of the hydraulic turbocharger and the second fluid (e.g., low-pressure frac fluid) may enter the hydraulic turbocharger on a second side. In operation, the flow of the first fluid drives a first turbine coupled to a shaft. As the first turbine rotates, the shaft transfers power to a second turbine that increases the pressure of the second fluid, which drives the second fluid out of the hydraulic turbocharger and down a well 16 during fracturing operations. In an embodiment using an isobaric pressure exchanger (IPX), the first fluid (e.g., high-pressure proppant free fluid) enters a first side of the hydraulic energy transfer system where the first fluid contacts the second fluid (e.g., low-pressure frac fluid) entering the IPX on a second side. The contact between the fluids enables the first fluid to increase the pressure of the second fluid, which drives the second fluid out of the IPX and down a well for fracturing operations. The first fluid similarly exits the IPX, but at a low-pressure after exchanging pressure with the second fluid.

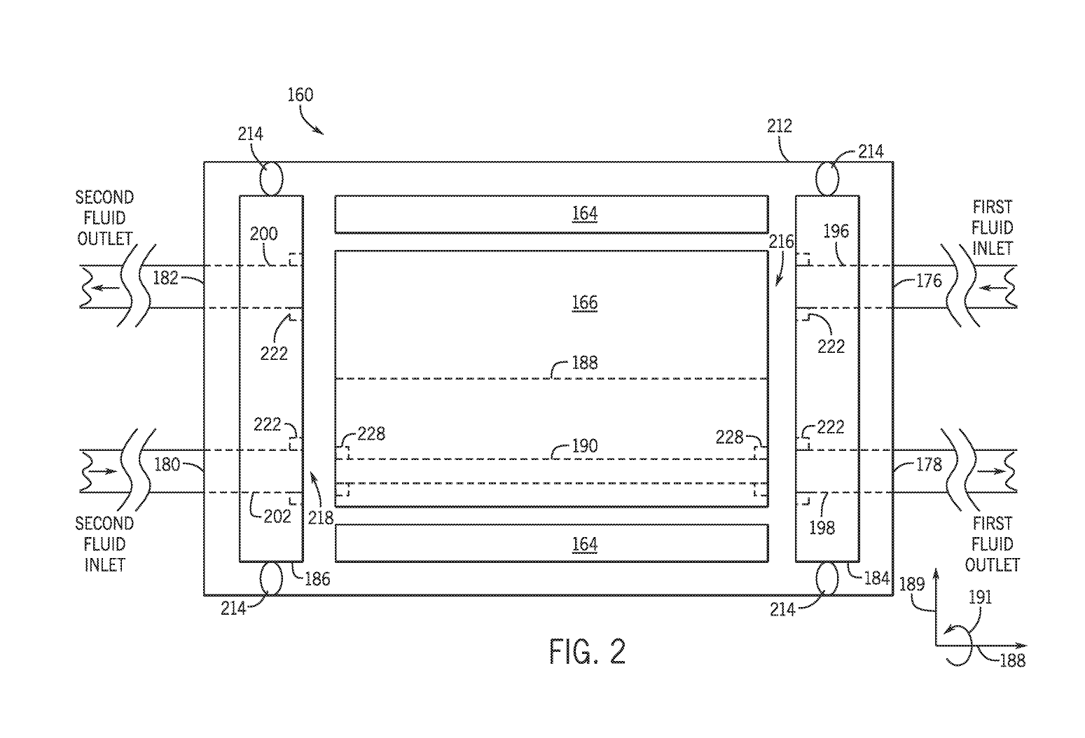

As used herein, the isobaric pressure exchanger (IPX) may be generally defined as a device that transfers fluid pressure between a high-pressure inlet stream and a low-pressure inlet stream at efficiencies in excess of approximately 50%, 60%, 70%, or 80% without utilizing centrifugal technology. In this context, high pressure refers to pressures greater than the low pressure. The low-pressure inlet stream of the IPX may be pressurized and exit the IPX at high pressure (e.g., at a pressure greater than that of the low-pressure inlet stream), and the high-pressure inlet stream may be depressurized and exit the IPX at low pressure (e.g., at a pressure less than that of the high-pressure inlet stream). Additionally, the IPX may operate with the high-pressure fluid directly applying a force to pressurize the low-pressure fluid, with or without a fluid separator between the fluids. Examples of fluid separators that may be used with the IPX include, but are not limited to, pistons, bladders, diaphragms and the like. In certain embodiments, isobaric pressure exchangers may be rotary devices. Rotary isobaric pressure exchangers (IPXs) 20, such as those manufactured by Energy Recovery, Inc. of San Leandro, Calif., may include spotfaces on components of the IPX, as described in detail below with respect to FIGS. 2-13. Rotary IPXs may be designed to operate with internal pistons to isolate fluids and transfer pressure with relatively little mixing of the inlet fluid streams. However, in some embodiments, rotary IPXs may not include internal pistons. Reciprocating IPXs may include a piston moving back and forth in a cylinder for transferring pressure between the fluid streams. Any IPX or plurality of IPXs may be used in the disclosed embodiments, such as, but not limited to, rotary IPXs, reciprocating IPXs, or any combination thereof. In addition, the IPX may be disposed on a skid separate from the other components of a fluid handling system, which may be desirable in situations in which the IPX is added to an existing fluid handling system.

FIG. 2 is a schematic diagram of an embodiment of an IPX 160. As shown in FIG. 2, the IPX 160 may have a variety of fluid connections, such as a first fluid inlet, a first fluid outlet, a second fluid inlet, and/or a second fluid outlet. In certain embodiments, the first and/or second fluids may include solids, such as particles, powders, debris, and so forth. Each of the fluid connections to the IPX may be made using flanged fittings, threaded fittings, bolted fittings, or other types of fittings. The IPX may include a rotating component, such as a rotor, which may rotate in the circumferential direction. As shown, the IPX 160 includes an axial axis 188, a radial axis 189, and a circumferential axis 191.

It will be appreciated that FIG. 2 is a simplified view of the rotary IPX 160 and certain details have been omitted for clarity. In the illustrated embodiment, the rotary IPX 160 includes a housing 212 (e.g., annular housing) containing a sleeve 164 (e.g., annular sleeve), a rotor 166, and end covers 184, 186, among other components. For example, seals 214 (e.g., annular seals) may be disposed between the housing 212 and the end covers 184, 186 to substantially contain the first and second fluids 208, 206 within the housing 212. That is, the seals 214 may extend circumferentially about the end covers 184, 186. However, in other embodiments, the seals 214 may not be disposed about the end cover 184, thereby substantially enabling the first fluid 208 to flow between the housing 212 and the sleeve 164, as well as the sleeve 164 and the rotor 166. As will be described in detail below, a high pressure (HP) first fluid 208 may enter the rotary IPX 160 through an inlet 176 and an aperture 196 to drive a low pressure (LP) second fluid 206 out of a channel 190.

In FIG. 2, a first interface 216 is positioned axially between the aperture 196 and the rotor 166. At the first interface 216, the first fluid 208 enters the channel 190, thereby driving the second fluid 206 from the channel 190 and out of the rotor 166 via an aperture 200. Additionally, a second interface 218 is positioned axially between an aperture 202 and the rotor 166. At the second interface 218, the second fluid 208 enters the channel 190, thereby driving the first fluid 208 from the channel 190 and out of the rotor 166 via an aperture 198. In certain embodiments, as the rotor 166 rotates and fluidly couples the apertures 196, 198, 200, 202 to the channels 190, a point contact may form between the channel 190 and the apertures 196, 198, 200, 202. As used herein, a point contact refers to an interface formed between two flow paths having different geometries. As will be described below, the point contact forms a substantially reduced cross sectional flow area. In other words, the point contact temporarily increases the velocity of fluid flowing through the point contact.

In the illustrated embodiment, the end covers 184, 186 and the rotor 166 include spotfaces 222, 228. As used herein, spotface refers to a recessed feature on a surface extending radially, circumferentially, and/or axially relative to an opening or aperture. In other words, a spotface is a flow guide feature (e.g., flow feed feature, flow transition feature), configured to receive and a direct a fluid toward an axially adjacent flow path. In certain embodiments, the spotface may be formed by machining, casting, molding, or any other suitable manufacturing process. The spotface is configured to facilitate a transfer of a fluid between axially adjacent openings (e.g., between an opening at a high pressure and an opening at a low pressure) by increasing a surface area (e.g., cross sectional flow area) between the two openings during fluid transfer. As will be described in detail below, the spotfaces are configured to form a line contact between the interfaces of the rotor 166 and the apertures 196, 198, 200, 202. As used herein, a line contact refers to an elongated contact interface formed between two flow paths. As will be described below, the line contact facilitates the formation of a larger cross sectional flow area faster than a point contact. Accordingly, velocities of the first and second fluids 208, 206 may be reduced because of the line contact, thereby minimizing the likelihood of erosion between the channels 190 and the apertures 196, 198, 200, 202.

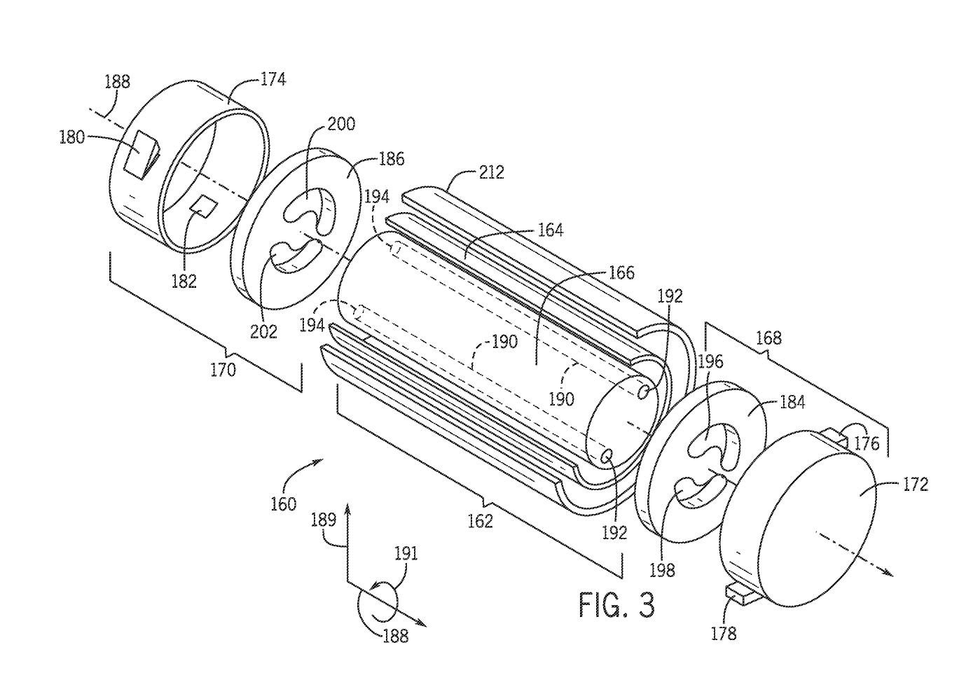

FIG. 3 is an exploded perspective view of an embodiment of the rotary isobaric pressure exchanger 160 (rotary IPX) capable of transferring pressure and/or work between the first and second fluids with minimal mixing of the fluids. The rotary IPX 160 may include a generally cylindrical body portion 162 that includes the sleeve 164 and the rotor 166 disposed within the housing 212. The rotary IPX 160 may also include two end caps 168 and 170 that include manifolds 172 and 174, respectively. Manifold 172 includes respective inlet and outlet ports 176 and 178, while manifold 174 includes respective inlet and outlet ports 180 and 182. In operation, these inlet ports 176, 180 enabling the first fluid to enter the rotary IPX 160 to exchange pressure, while the outlet ports 178, 182 enable the first fluid to then exit the rotary IPX 160. In operation, the inlet port 176 may receive the HP first fluid, and after exchanging pressure, the outlet port 178 may be used to route the LP first fluid out of the rotary IPX 160. Similarly, inlet port 180 may receive the LP second fluid 206 and the outlet port 182 may be used to route the HP second fluid 206 out of the rotary IPX 160. The end caps 168 and 170 include respective end covers 184 and 186 disposed within respective manifolds 172 and 174 that enable fluid sealing contact with the rotor 166. The rotor 166 may be cylindrical and disposed in the sleeve 164, which enables the rotor 166 to rotate about the axial axis 188 (e.g., longitudinal axis). The rotor 166 may have a plurality of channels 190 extending substantially longitudinally through the rotor 166 with openings 192 and 194 at each end arranged symmetrically about the longitudinal axis 188. The openings 192 and 194 of the rotor 166 are arranged for hydraulic communication with inlet and outlet apertures 196 and 198; and 200 and 202 in the end covers 184 and 186, in such a manner that during rotation the channels 190 are exposed to fluid at high-pressure and fluid at low-pressure. As illustrated, the inlet and outlet apertures 196 and 198, and 200 and 202 may be designed in the form of arcs or segments of a circle (e.g., C-shaped).

In some embodiments, a controller using sensor feedback may control the extent of mixing between the first and second fluids in the rotary IPX 160, which may be used to improve the operability of the fluid handling system. For example, varying the proportions of the first and second fluids entering the rotary IPX 160 allows the plant operator to control the amount of fluid mixing within the hydraulic energy transfer system. Three characteristics of the rotary IPX 160 that affect mixing are: (1) the aspect ratio of the rotor channels 190, (2) the short duration of exposure between the first and second fluids, and (3) the creation of a fluid barrier (e.g., an interface) between the first and second fluids within the rotor channels 190. First, the rotor channels 190 are generally long and narrow, which stabilizes the flow within the rotary IPX 160. In addition, the first and second fluids may move through the channels 190 in a plug flow regime with very little axial mixing. Second, in certain embodiments, the speed of the rotor 166 reduces contact between the first and second fluids. For example, the speed of the rotor 166 may reduce contact times between the first and second fluids to less than approximately 0.15 seconds, 0.10 seconds, or 0.05 seconds. Third, a small portion of the rotor channel 190 is used for the exchange of pressure between the first and second fluids. Therefore, a volume of fluid remains in the channel 190 as a barrier between the first and second fluids. All these mechanisms may limit mixing within the rotary IPX 160. Moreover, in some embodiments, the rotary IPX 160 may be designed to operate with internal pistons that isolate the first and second fluids while enabling pressure transfer.

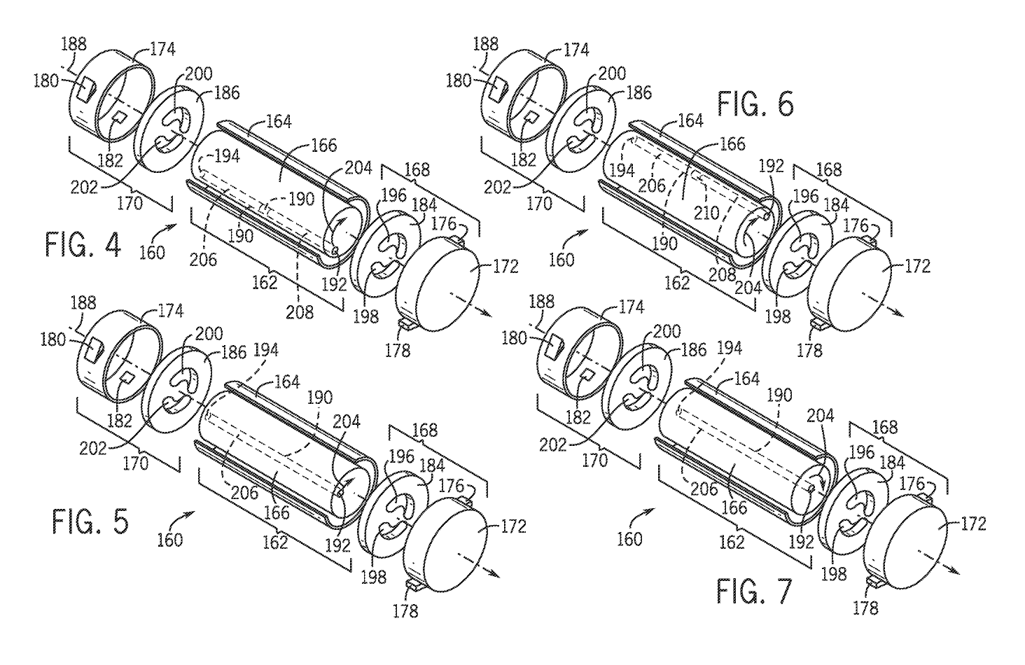

FIGS. 4-7 are exploded views of an embodiment of the rotary IPX 160 illustrating the sequence of positions of a single channel 190 in the rotor 166 as the channel 190 rotates through a complete cycle. It is noted that FIGS. 2-5 are simplifications of the rotary IPX 160 showing one channel 190, and the channel 190 is shown as having a circular cross sectional shape. In other embodiments, the rotary IPX 160 may include a plurality of channels 190 with the same or different cross sectional shapes (e.g., circular, oval, square, rectangular, polygonal, etc.). Thus, FIGS. 2-5 are simplifications for purposes of illustration, and other embodiments of the rotary IPX 160 may have configurations different from that shown in FIGS. 2-5. As described in detail below, the rotary IPX 160 facilitates pressure exchange between the first and second fluids by enabling the first and second fluids to momentarily contact each other within the rotor 166. In certain embodiments, this exchange happens at speeds that result in limited mixing of the first and second fluids.

In FIG. 4, the channel opening 192 is in a first position. In the first position, the channel opening 192 is in fluid communication with the aperture 198 in endplate 184 and therefore with the manifold 172, while opposing channel opening 194 is in hydraulic communication with the aperture 202 in end cover 186 and by extension with the manifold 174. As will be discussed below, the rotor 166 may rotate in the clockwise direction indicated by arrow 204. In operation, LP second fluid 206 passes through end cover 186 and enters the channel 190, where it contacts a LP first fluid 208 at a dynamic fluid interface 210. The second fluid 206 then drives the first fluid 208 out of the channel 190, through end cover 184, and out of the rotary IPX 160. However, because of the short duration of contact, there is minimal mixing between the second fluid 206 and the first fluid 208. As will be appreciated, a pressure of the second fluid 206 is greater than a pressure of the first fluid 208, thereby enabling the second fluid 206 to drive the first fluid 208 out of the channel 190.

In FIG. 5, the channel 190 has rotated clockwise through an arc of approximately 90 degrees. In this position, the outlet 194 is no longer in fluid communication with the apertures 200 and 202 of end cover 186, and the opening 192 is no longer in fluid communication with the apertures 196 and 198 of end cover 184. Accordingly, the LP second fluid 206 is temporarily contained within the channel 190.

In FIG. 6, the channel 190 has rotated through approximately 180 degrees of arc from the position shown in FIG. 2. The opening 194 is now in fluid communication with aperture 200 in end cover 186, and the opening 192 of the channel 190 is now in fluid communication with aperture 196 of the end cover 184. In this position, the HP first fluid 208 enters and pressurizes the LP second fluid 206 driving the second fluid 206 out of the fluid channel 190 and through the aperture 200 for use in the system or disposal.

In FIG. 7, the channel 190 has rotated through approximately 270 degrees of arc from the position shown in FIG. 6. In this position, the outlet 194 is no longer in fluid communication with the apertures 200 and 202 of end cover 186, and the opening 192 is no longer in fluid communication with the apertures 196 and 198 of end cover 184. Accordingly, the first fluid 208 is no longer pressurized and is temporarily contained within the channel 190 until the rotor 166 rotates another 90 degrees, starting the cycle over again.

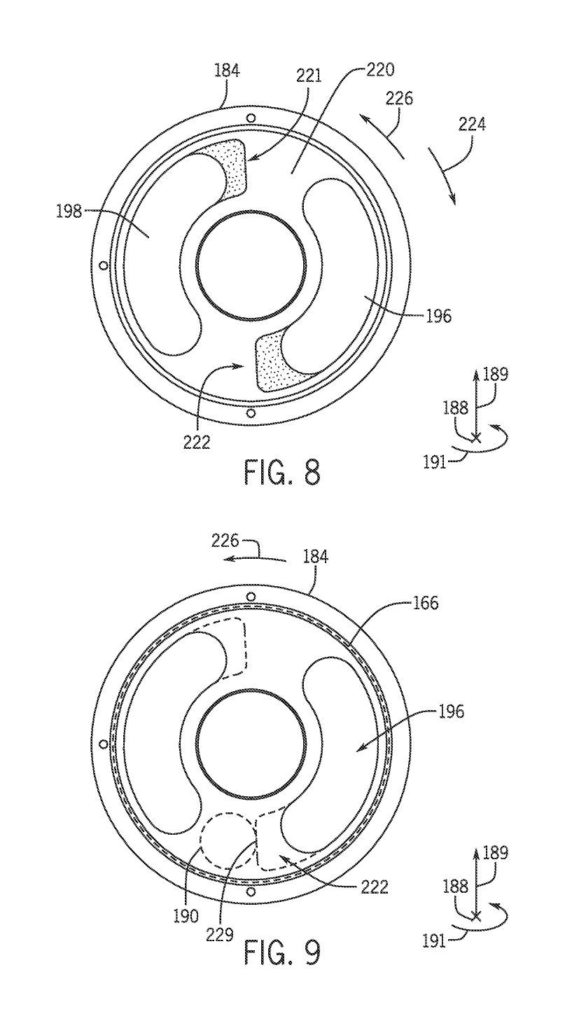

FIG. 8 is an axial view of an interior surface 220 of the end cover 184 (e.g., the HP inlet end cover) having spotfaces 222 on the apertures 196, 198. The spotfaces 222 are circumferentially extending recessed features of the end cover 184, forming depressions on the interior surface 220. In certain embodiments, the spotfaces 222 are graded features that extend circumferentially in a direction 224, opposite the direction of rotation 226 of the rotor 166. The spotfaces 222 are configured to increase the surface area as the first fluid 208 is directed toward the channels 190 by enabling flow to the channel 190 before the channel 190 is fully aligned with the apertures 196, 198. Increasing the surface area decreases the velocity of the first fluid 208 and also increases the duration for first fluid 208 to enter the channel 190, thereby increasing the pressure drop of the first fluid 208. In other words, the spotfaces 222 are configured to dampen a pressure transition between the channel 190 and the apertures 196, 198, 200, 202. As mentioned above, the spotfaces 222 are positioned on the leading edge of the apertures 196, 198 such that the spotfaces 222 fluidly couple the channels 190 to the apertures 196, 198 as the rotor 166 rotates in the direction 226.

FIG. 9 is an axial view of the end cover 184 overlaid on the rotor 166. As will be appreciated, during operation, the rotor 166 will be proximate to the interior surface 220 of the end cover 184. In the illustrated embodiment, the rotor 166 rotates in the direction of rotation 226 to bring the channels 190 into fluid contact with the aperture 196. As mentioned above, a point contact 229 is formed between the channel 190 and the aperture 198. The point contact 229 is due in part to the oppositely curved shapes (e.g., perimeters of the channel 190 and the spotface 222 of the aperture 196). As such, the point contact 229 represents the initial overlap of the channel 190 and the spotface 222 of the aperture 196. As mentioned above, the cross sectional flow area of the point contact 229 is smaller than the cross sectional flow area of the channel 190, thereby increasing the velocity of the fluid entering the channel 190.

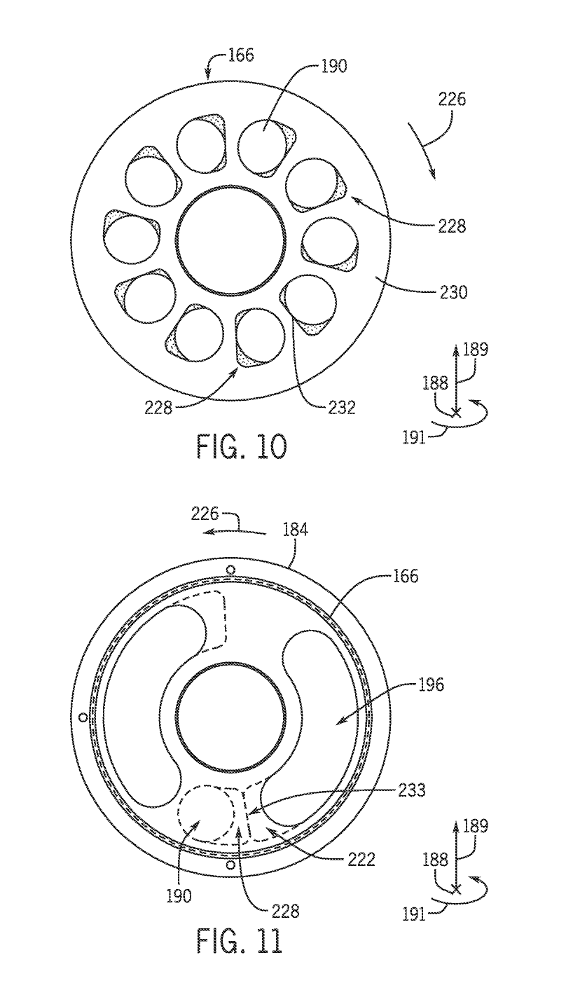

FIG. 10 is an axial view of the rotor 166 having spotfaces 228 formed (e.g., machined) onto an exterior surface 230 of the channels 190. As shown, the spotfaces 228 are formed onto a leading edge 232 of the rotor 166. In the illustrated embodiment, the leading edge 232 is the edge of the channel 190 that will encounter the apertures (e.g., aperture 196) first along the direction of rotation 226. The spotfaces 228 are configured to substantially align with the spotsfaces 222 of the apertures 196, 198, 200, 202 of the end covers 184, 186. However, in certain embodiments, the spotfaces 228 may be larger than the spotfaces 222, smaller than the spotfaces 222, or shaped differently than the spotfaces 222. Accordingly, the alignment of the spotfaces 222, 228 forms a line contact between the channel 190 and the apertures (e.g., aperture 196), thereby increasing the surface area between the channel 190 and the aperture and reducing the velocity of the fluid. In mentioned above, the line contact refers to the elongated contact interface at the initial overlap between the spotface 228 of the channel 190 and the spotface 222 of the aperture (e.g., the aperture 196).

As mentioned above, the spotfaces 222 are configured to increase the surface area for fluid flow into the channels 190. For example, a portion of the first fluid 208 may exit the aperture 196 and enter the spotface 228 of the channel 190 before entering the channel 190. As a result, the velocity of the fluid may be decreased because of the larger surface area of the spotface 228, as compared to a smaller overlapping section of the channel 190. Accordingly, the pressure transition between the channel 190 and the aperture 196 may be dampened by the spotfaces 222, 228 and the likelihood of erosion as the fluid enters the channels 190 may be reduced. Furthermore, the larger surface area may increase the duration of time in which the fluid is flowing into the channel 190. In certain embodiments, the additional time enables the fluid pressure to drop or rise before entering or leaving the channel 190, thereby reducing the velocity of the fluid and reducing the likelihood of erosion. In certain embodiments, the channels 190 may include spot faces on each side of the channels 190. Additionally, in certain embodiments, the spotfaces 228 may be on each channel 190. However, in other embodiments, the spotfaces 228 may not be on each channel 190. For example, the spotfaces 228 may be included on alternating channels 190.

FIG. 11 is an axial view of the end cover 184 overlaid on the rotor 166. As will be appreciated, during operation, the rotor 166 will be proximate to the interior surface 220 of the end cover 184. However, for clarity, the rotor 166 is positioned opposite the interior surface 220 to illustrate the alignment of the channels 190 and the aperture 198. In the illustrated embodiment, the rotor 166 rotates in the direction of rotation 226 to bring the channels 190 into fluid contact with the aperture 198. As shown, the channels 190 include the spotfaces 228 on the leading edge 232 of the channels 190. As a result, as the channels 190 move into fluid contact with the aperture 198, a line contact 233 is formed between the spotface 228 on the channel 190 and the spotface 222 on the aperture 198. As a result, a larger cross sectional flow area is formed between the channel 190 and the aperture 198, as compared to embodiments where the point contact 229 is formed.

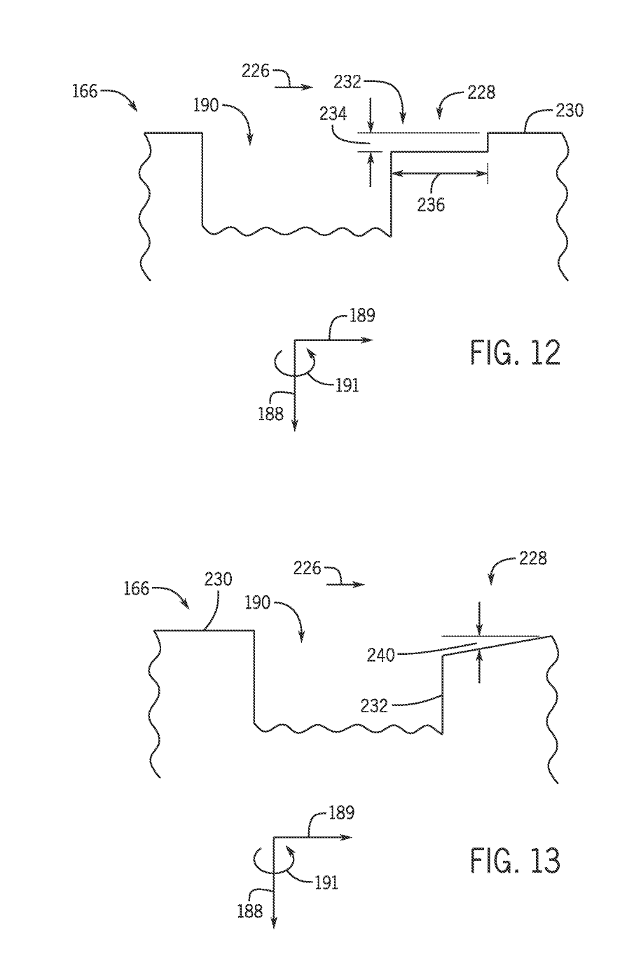

FIGS. 12-13 are cross-sectional views of embodiments of the spotface 228 disposed on the exterior surface 230 of the rotor 166. In FIG. 12, the spotface 228 has a uniform depth 234. In certain embodiments, the depth 234 is approximately 1.016 mm deep. However, in other embodiments, the depth 234 may be 2.54×10⁻³ mm, 0.127 mm, 1.27 mm, 0.762 mm, 0.508 mm, 0.254 mm, 12.1 mm, 2.54 mm, or any other suitable depth. Moreover, the depth 234 may be between 2.54×10⁻³ mm and 0.127 mm, between 0.127 mm and 1.27 mm, between 1.27 mm and 0.762 mm, between 0.762 mm and 0.254 mm, between 0.254 mm and 2.54 mm, or any other suitable range. Moreover, in other embodiments, the depth 234 may be approximately 1/100 the radius of the rotor 166, approximately 1/50 the radius of the rotor 166, approximately 1/20 the radius of the rotor 166, approximately 1/10 the radius of the rotor, or any other suitable depth. Furthermore, the depth 234 may be between approximately 1/100 the radius of the rotor 166 and approximately 1/50 the radius of the rotor 166, between approximately 1/50 the radius of the rotor 166 and approximately 1/20 the radius of the rotor 166, between approximately 1/20 the radius of the rotor 166 and approximately 1/10 the radius of the rotor 166, or any other suitable range. In certain embodiments, the depth 234 may be configured to be greater than a thickness of particles suspended in the fluid.

Additionally, the spotface 228 extends from the leading edge 232 a distance 236 along the direction of rotation 226 of the rotor 166. In certain embodiments, the distance 236 may be approximately 1/20 the circumferential extent of the rotor 166. However, in other embodiments the distance 236 may be approximately 1/100 the circumferential extent, approximately 1/50 the circumferential extent, approximately 1/10 the circumferential extent, or any other suitable distance. Also, the distance 236 may be between approximately 1/100 the circumferential extent and approximately 1/50 the circumferential extent, between approximately 1/50 the circumferential extent and approximately 1/20 the circumferential extent, between approximately 1/20 the circumferential extent and approximately 1/10 the circumferential extent, or any other suitable range. Furthermore, the distance 236 may be approximately 1/100 the radius of the rotor 166, approximately 1/50 the radius of the rotor 166, approximately 1/20 the radius of the rotor 166, approximately 1/10 the radius of the rotor, or any other suitable depth. Furthermore, the distance 236 may be between approximately 1/100 the radius of the rotor 166 and approximately 1/50 the radius of the rotor 166, between approximately 1/50 the radius of the rotor 166 and approximately 1/20 the radius of the rotor 166, between approximately 1/20 the radius of the rotor 166 and approximately 1/10 the radius of the rotor 166, or any other suitable range. Moreover, in certain embodiments, the distance 236 may extend approximately ½ degree about the circumference of the rotor 166, approximately 1 degree about the circumference of the rotor 166, approximately 5 degrees about the circumference of the rotor 166, approximately 10 degrees about the circumference of the rotor 166, or approximately 20 degrees about the circumference of the rotor 166. Additionally, the distance 236 may be between approximately ½ degree about the circumference of the rotor 166 and approximately 1 degree about the circumference of the rotor 166, between approximately 1 degree about the circumference of the rotor 166 and approximately 5 degrees about the circumference of the rotor 166, between approximately 5 degrees about the circumference of the rotor 166 and approximately 10 degrees about the circumference of the rotor 166, between approximately 10 degrees about the circumference of the rotor 166 and approximately 20 degrees about the circumference of the rotor 166, or any other suitable range. Moreover, in certain embodiments, the distance 236 may be configured to accommodate a desired or target rotational speed of the rotor 166. As a result, an additional flow area is formed proximate to the channel 190, thereby reducing the velocity of the fluid as the fluid is directed toward the channel 190.

Turning to FIG. 13, the spotface 228 includes a ramped surface 238 (e.g., a linearly tapered surface, a curved surface, a multi-stepped surface, etc.). In other words, the surface 238 is non-parallel relative to the exterior surface 230 of the rotor 166. As shown, the ramped surface 238 is at an angle 240 relative to the exterior surface 230 of the rotor 166. In the illustrated embodiment, the angle 240 is approximately 60 degrees. However, in other embodiments, the angle may be approximately 90 degrees, approximately 80 degrees, approximately 70 degrees, approximately 50 degrees, approximately 40 degrees, approximately 30 degrees, approximately 20 degrees, approximately 10 degrees, approximately 5 degrees, or any other suitable value. Moreover, the angle 240 may have a range between approximately 90 degrees and approximately 70 degrees, between approximately 70 degrees and approximately 50 degrees, between approximately 50 degrees and approximately 30 degrees, between approximately 30 degrees and approximately 10 degrees, or any other suitable range. The ramped surface extends from the leading edge 232 along the direction of rotation 226. The ramped surface 238 is configured to direct the fluid toward the channel 190, while also increasing the flow area to reduce the velocity of the fluid as the fluid is directed toward the channel 190. In certain embodiments, the rotor 166 may include a combination of the embodiments illustrated in FIGS. 12 and 13. For example, alternating channels 190 may include the spotfaces 228 illustrated in FIGS. 12 and 13. Moreover, in certain examples, the spotfaces 228 may include a combination of the embodiments illustrated in FIGS. 12 and 13. For instance, the spotface 228 may extend a first distance with a generally uniform depth and also include a ramped surface extending a second distance. Additionally, in certain embodiments, spotfaces 228 may include curved edges, curved surfaces, or a combination thereof.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a rotary isobaric pressure exchanger (IPX) comprising a rotor, wherein the rotor comprises a first spotface formed on a first exterior surface of a first longitudinal end of the rotor adjacent to at least one channel, and wherein the at least one channel is disposed within the rotor and is configured to receive and to discharge a fluid flow.

2. The system of claim 2, wherein the rotor comprises a plurality of channels disposed within the rotor and configured to receive and to discharge a fluid flow.

3. The system of claim 2, wherein the first spotface is disposed adjacent to a first channel of the plurality of channels, the rotor comprises a second spotface formed on the first exterior surface of the first longitudinal end of the rotor adjacent to a second channel of the plurality of channels.

4. The system of claim 2, wherein the rotor comprises a plurality of spotfaces formed on the first exterior surface of the first longitudinal end of the rotor, and wherein a respective spotface of the plurality of spotfaces is formed adjacent each channel of the plurality of channels.

5. The system of claim 2, wherein the rotor comprises a second spotface formed on a second exterior surface of a second longitudinal end of the rotor opposite the first longitudinal end, and the second spotface is formed adjacent a channel of the plurality of channels.

6. The system of claim 5, wherein the rotor comprises a first plurality of spotfaces formed on the first exterior surface of the first longitudinal end of the rotor, a respective spotface of the first plurality of spotfaces is formed adjacent each channel of the plurality of channels, the rotor comprises a second plurality of spotfaces formed on the second exterior surface of the second longitudinal end of the rotor, and a respective spotface of the second plurality of spotfaces is formed adjacent each channel of the plurality of channels.

7. The system of claim 1, wherein the first spotface comprises a constant depth relative to the first exterior surface.

8. The system of claim 1, wherein the first spotface comprises a depth that varies relative to the first exterior surface.

9. The system of claim 1, wherein the first spotface is non-parallel relative to the first exterior surface.

10. The system of claim 1, wherein the first spotface is angled relative to the first exterior surface at an angle between 5 and 90 degrees.

11. The system of claim 1, wherein the rotary IPX comprises a first end cover having a first surface that interfaces with and slidingly and sealingly engages the first exterior surface of the rotor, and wherein the first end cover has at least one fluid inlet and at least one fluid outlet that during rotation of the rotor about a rotational axis in a circumferential direction alternately fluidly communicate with the at least one channel.

12. The system of claim 11, wherein the at least one channel comprises a leading edge that is an initial portion of the at least one channel to alternately fluidly communicate with the at least one fluid inlet and the at least one fluid outlet during rotation of the rotor about the rotational axis in the circumferential direction, and the first spotface is formed in the first exterior surface at the leading edge of channel to enable the first spotface to alternately fluidly communicate with the at least one fluid inlet and the at least one fluid outlet prior to any other portion of the at least one channel.

13. The system of claim 12, wherein the first spotface and the at least one fluid inlet and the at least one fluid outlet alternatively form a respective line contact when the first spotface initially and alternately fluidly communicates with the at least one fluid inlet and the at least one fluid outlet.

14. The system of claim 13, wherein the respective line contact extends in a radial direction relative to the rotational axis.

15. The system of claim 1, comprising a frac system having the rotary IPX, wherein the rotary IPX is configured to exchange pressures between a frac fluid having proppants and a proppant free fluid.

16. A rotary isobaric pressure exchanger (IPX) for transferring pressure energy from a high pressure first fluid to a low pressure second fluid, comprising:
a cylindrical rotor configured to rotate circumferentially about a rotational axis and having a first end face and a second end face disposed opposite each other with a plurality of channels extending axially therethrough between respective apertures located in the first and second end faces;
a first end cover having a first surface that interfaces with and slidingly and sealingly engages the first end face, wherein the first end cover has at least one first fluid inlet and at least one first fluid outlet that during rotation of the cylindrical rotor about the rotational axis alternately fluidly communicate with at least one channel of the plurality of channels; and
a second end cover having a second surface that interfaces with and slidingly and sealingly engages the second end face, wherein the second end cover has at least one second fluid inlet and at least one second fluid outlet that during rotation of the cylindrical rotor about the rotational axis alternately fluidly communicate with at least one channel of the plurality of channels; and
wherein the cylindrical rotor comprises a first spotface formed on the first end face adjacent to a first channel of the plurality of channels.

17. The rotary IPX of claim 16, wherein cylindrical rotor comprises a second spotface formed on the second end face adjacent to the first channel or a second channel of the plurality of channels.

18. The rotary IPX of claim 16, wherein the first channel comprises a leading edge that is an initial portion of the first channel to alternately fluidly communicate with the at least one first fluid inlet and the at least one first fluid outlet during rotation of the cylindrical rotor, and the first spotface is formed in the first exterior surface at the leading edge of the first channel to enable the first spotface to alternately fluidly communicate with the at least one first fluid inlet and the at least one first fluid outlet prior to any other portion of the first channel.

19. The rotary IPX of claim 18, wherein the first spotface and the at least one first fluid inlet and the at least one first fluid outlet alternatively form a respective line contact when the first spotface initially and alternately fluidly communicates with the at least one fluid inlet and the at least one fluid outlet, and the respective line contact extends in a radial direction relative to the rotational axis.

20. A rotary isobaric pressure exchanger (IPX) for transferring pressure energy from a high pressure first fluid to a low pressure second fluid, comprising:
a cylindrical rotor configured to rotate circumferentially about a rotational axis and having a first end face and a second end face disposed opposite each other with a plurality of channels extending axially therethrough between respective apertures located in the first and second end faces;
a first end cover having a first surface that interfaces with and slidingly and sealingly engages the first end face, wherein the first end cover has at least one first fluid inlet and at least one first fluid outlet that during rotation of the cylindrical rotor about the rotational axis alternately fluidly communicate with at least one channel of the plurality of channels; and
a second end cover having a second surface that interfaces with and slidingly and sealingly engages the second end face, wherein the second end cover has at least one second fluid inlet and at least one second fluid outlet that during rotation of the cylindrical rotor about the rotational axis alternately fluidly communicate with at least one channel of the plurality of channels; and
wherein the cylindrical rotor comprises a first spotface formed on the first end face at a first leading edge of a first channel of the plurality of channels, and the first end cover comprises a second spotface formed on the first surface at a second leading edge of the at least one first fluid inlet or the at least one first fluid outlet, and wherein the first leading edge is an initial portion of the first channel to alternately fluidly communicate with the at least one fluid inlet and the at least one fluid outlet during rotation of the cylindrical rotor, the second leading edge of the at least one first fluid inlet or the at least one first fluid outlet is an initial portion of the at least one first fluid inlet or the at least one first fluid outlet to fluidly communicate with the first channel during rotation of the cylindrical rotor, and the first leading edge and the second leading edge form a line contact when the first and second spotfaces initially fluidly communicate with each other.
